(19) United States
(12) Patent Application Publication
(10) Pub. No.: US 2004/0051739 A1
(43) Pub. Date: Mar. 18, 2004

(54) Alarm graphic editor with automatic update

(76) Inventors: Michael J. Schmickley, Algonquin, IL (US); James Han, Long Grove, IL (US)

Correspondence Address: Siemens Corporation, Intellectual Property Department, 170 Wood Avenue South, Iselin, NJ, 08830, US

(21) Appl. No.: 10/434,491

(22) Filed: May 8, 2003

Related U.S. Application Data
(60) Provisional application No. 60/390,341, filed on Jun. 20, 2002.
(60) Provisional application No. 60/431,899, filed on Dec. 9, 2002.

(51) Int. Cl. G09G 5/00

(52) U.S. Cl. 345/772

(57) ABSTRACT

A method is used in a graphical display for displaying alarm indications in a system, the graphical display including hierarchical elements. The method includes storing a first set of identifiers associated with a graphic element, the graphic element including one or more child elements, a first child element including a second set of identifiers, the first set of identifiers including identifiers corresponding to at least each of the second set of identifiers. The method further includes receiving a command changing a status of the first child element, the changing of status changing a number of identifiers included in the second set. The method also includes automatically updating the first set of identifiers responsive to the command.

This application claims the benefit of U.S. Provisional Patent Application Serial No. 60/390,341, filed Jun. 20, 2002, which is incorporated herein by reference, and further claims the benefit of U.S. Provisional Patent Application Serial No. 60/431,899, filed Dec. 9, 2002, which is also incorporated herein by reference.

### CROSS-REFERENCE TO RELATED APPLICATIONS

Cross-reference is made to co-pending application, Attorney Docket No. 2002 P 09832 US 01 (1867-0018) , filed on even date herewith, entitled “Integrated Communication of Building Control System and Fire Safety System Information”, which is owned by the owner of the present application and incorporated herein by reference. Cross-reference is also made to co-pending application, Attorney Docket No. 2003 P 06283 (1867-0024), filed on even date herewith, entitled “Smoke Detector Maintenance Indication Method and Apparatus”, which is owned by the owner of the present application and incorporated herein by reference.

### FIELD OF THE INVENTION

The present invention relates generally to graphical display methods and apparatus, and more particularly, to graphical display of alarms in systems.

### BACKGROUND OF THE INVENTION

Many complex systems generate alarms if one or more elements or conditions within or monitored by the system are operating out of boundaries. Alarms may be generated for many reasons, including notification of a potentially dangerous or destructive condition, or of a type of malfunction affecting productivity. For example, a building heating, ventilation and air conditioning (“HVAC”) system may exhibit various alarm conditions that indicate anything from a serious health threat, such as an air conditioning “chiller” plant failure, to a minor error status report, such as the failure of a single temperature sensor. Building fire systems also, for obvious reasons, generate various alarms ranging from the existence of a fire and/or smoke condition to the need for routine maintenance for one or more smoke detectors.

Large building systems increasing employ data networks to transmit information, including alarm information, to one or more “control” locations in which alarm status and other system status information may be monitored. The Apogee brand building automation system, available from Siemens Building Technologies, Inc. of Buffalo Grove, Ill., is an example of a building control system that employs data networks to communicate alarm information as well as other information to one or more operator stations.

A continuing issue with large building systems arises from the presentation of system information, and particularly alarms, to system operators. Building systems often employ hundreds or thousands of devices that generate data. For example, a fire safety system for a campus of buildings may include scores of smoke detectors, emergency pull stations (the red, pull handles that trigger an alarm), heat detectors and other devices that generate data and/or alarms of different magnitude. It is important that an operator be able to obtain alarms and identify their source location within the building or site in an expeditious manner.

In the past, alarm information was presented to one or more control computers and then displayed on the computer display in a primarily text-based format. The textual information would typically identify of the device or panel that generated the alarm. The textual information might also identify the severity of an alarm. The problem with a text-based alarm notification system is the difficulty in navigating through alarm information in a meaningful way. In particular, text information is typically provided as a linear list, which provides little or no intuitive information on location, distribution or grouping of alarms.

To address such drawbacks, graphical user interfaces have been employed in fire safety systems, as well as other systems. Graphical user interfaces allow users to navigate through alarm notification information in an intuitive and convenient way. One such graphical user interface is a system that allows the user to view hierarchical system maps that show various levels of detail (i.e. zoom levels). For example, one screen may show a map of an entire campus of several buildings. Another zoom level screen may show one of the buildings of the campus in further detail, illustrating the different floors of the building. Still another screen may show one of the floors of the building, illustrating a floor plan of the different rooms or zones of the floor. Such a system allows the user to selectively monitor the entire site or select portions of the site. An example of a system with these graphical capabilities is the FireWorks fire system workstation available from Edwards System Technologies, Inc, of Sarasota, Fla. (The “ETS system”)

In general, the ETS system provides alarm indications within the graphic illustrations of a building or campus. The installer or administrator of the system may cause alarm indications to be displayed within any viewable graphic pages by linking a particular alarm to that graphics page. While such as system allows for flexibility in defining where and when graphic alarm indications are displayed, the complexities of determining which graphics should include which alarm indications can be daunting, particularly in large buildings.

Accordingly, there exists a need for a system that allows for more convenient and intuitive set-up, editing and deletion of alarm indications on various displayed graphics of a building system.

### SUMMARY OF THE INVENTION

The present invention addresses the above needs, as well as others, by providing a system of hierarchical graphic elements in which alarm indications are automatically linked to (or links removed from) upstream graphic elements responsive to any downstream changes in alarm-graphic links. In other words, in the hierarchical system, if an alarm indication link is added to a graphic element, then upstream or parent graphics are automatically updated to include that alarm indication link. As a consequence, alarm indications are automatically linked to (or de-linked from) related graphics in a building system to provide a logical and intuitive alarm indication presentation. The present invention simplifies set-up and modification of alarm graphics by eliminating the need for the system administrator to manually add or remove the same alarm links from each of the relevant graphics.

A first embodiment of the invention is a method for use in a graphical display for displaying alarm indications in a system, the graphical display including hierarchical elements. The method includes storing a first set of identifiers associated with a graphic element, the graphic element including one or more child elements, a first child element including a second set of identifiers, the first set of identifiers including identifiers corresponding to at least each of the second set of identifiers. The method further includes receiving a command changing a status of the first child element, the changing of status changing a number of identifiers included in the second set. The method also includes automatically updating the first set of identifiers responsive to the command.

Preferably, the method also includes the steps of displaying graphical information corresponding to the graphic element, obtaining an alarm associated with a first identifier, and displaying a graphical indication of the alarm if the first identifier is associated with the first set of identifiers.

A second embodiment of the invention is a system that includes a display, a processor and at least one storage device. The system displays alarm indications in a system, the system employing hierarchical graphical display elements. The processing circuit is coupled to the display and is operable to store in the at least one storage device a first set of identifiers associated with a graphic element, the graphic element including one or more child elements, a first child element including a second set of identifiers, the set list of identifiers including identifiers corresponding to at least each of the second set of identifiers. The processor is further operable to receive a command changing a status of the first child element, the changing of status changing a number of identifiers included in the second set. The processor is also operable to update the first set of identifiers responsive to the command.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a representation of a hierarchical graphical system that incorporates aspects of the present invention;

FIG. 2 shows an exemplary fire alarm network that incorporates principles of the present invention;

FIG. 2a shows a computer arrangement that may be used as the control station of the fire alarm network of FIG. 2;

FIG. 3 shows screen captures of a set of hierarchical graphical pages including a plurality of hierarchical graphical components in accordance with the present invention;

FIG. 4 shows a flow diagram of an exemplary set of operations of the control station of the fire alarm network of FIG. 2 in accordance with the present invention;

FIG. 5 shows a flow diagram of another exemplary set of operations of the control station of the fire alarm network of FIG. 2 in accordance with the present invention; and

FIG. 6 shows a flow diagram of yet another exemplary set of operations of the control station of the fire alarm network of FIG. 2 in accordance with the present invention.

### DETAILED DESCRIPTION

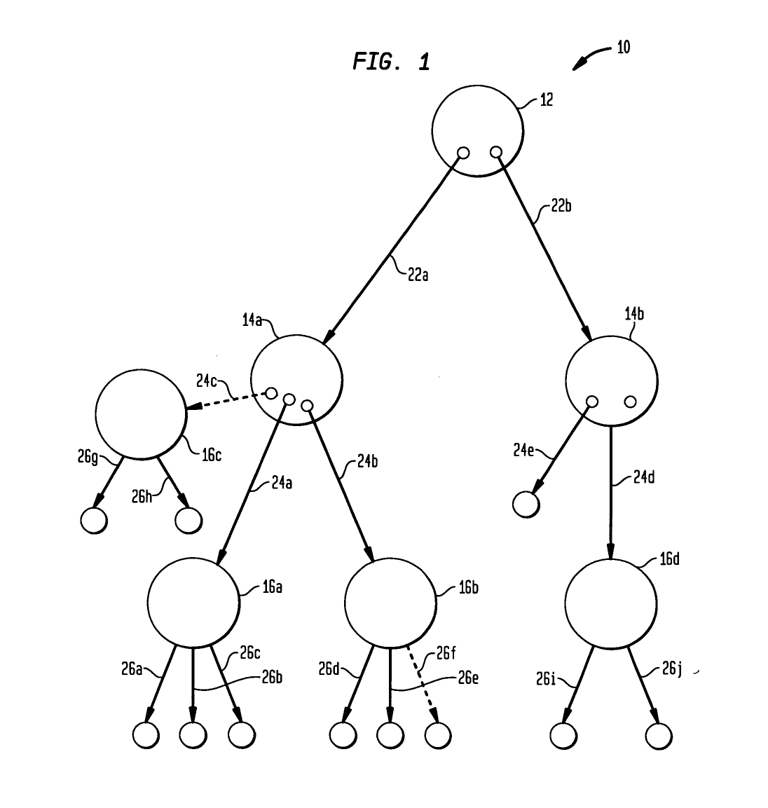

FIG. 1 shows a representation of a hierarchical graphical system that incorporates aspects of the present invention. The hierarchical graphical system 10 includes a first level graphic element 12, two second level graphic elements 14a and 14b, and a plurality of third level graphic elements 16a-16e. Each graphic element includes a displayable graphic and downstream links to other elements and/or data. For example, an element may or may not be associated with or linked to a physical device or other virtual device capable of exhibiting an alarm condition.

In general, as discussed herein, a graphic element is a construct representative of a graphically displayable image. A link as used herein is a construct that represents a connection between data elements within software. Links between graphic elements allow the operator to “traverse” the link to change the display from one element to the other element on the link. Such elements and links form can be used to form a hierarchical system such as the hierarchical system 10 shown in FIG. 1 by those of ordinary skill in the art. Links may also represent connections between a graphic element and a data value.

Referring now specifically to the system 10, the first level graphic element 12 has two links 22a and 22b which associate or “connect” the first level graphic element 12 with each of the second level graphic elements 14a and 14b, respectively. The links 22a and 22b allow, among other things, an operator that is current viewing the element 12 to request display of either of the second level graphics 14a and 14b. By way of example, the first level graphic 12 may be a graphical map or depiction of a campus of buildings, while the second level graphics 14a and 14b may be a graphical map or depiction of summary floor plan of two of those buildings. The links 22a and 22b may suitably be represented as selectable graphical icons or controls within the first level graphic 12. As a consequence, an operator may elect to display the second level graphic element 14a by selecting or “clicking” the icon or control associated with the link 22a.

In the embodiment described herein, the second level graphics 14a and 14b are descendants, and more particularly, child elements of the first level graphic element 12. The first level graphic element 12 is the parent of the second level graphic elements 14a and 14b. It will further be appreciated that any graphical icon associated with a link 22x may be considered to be a child element of the first level graphic element 12, as each link 22x has a direct one to one correlation with a second level graphic element 14x.

The second level graphic element 14a has two links 24a and 24b, analogous to links 22a and 22b, which associate the second level graphic element 14a with third level graphic elements 16a and 16b. The third level graphic elements 16a and 16b are child elements of the second level graphic element 14a, and are in general descendant elements of both the second level graphic element 14a and the first level graphic element 12a.

As discussed further below, a link 24c is shown as a dashed line because it is hereinafter discussed as an example of a link that is added by a user to the second level graphic element 14a. The addition of the link 24c results in the third level graphic element 16c becoming another descendant of the second level graphic element 14a and the first level graphic element 12a.

The third level graphic elements 16a and 16b preferably represent physical elements or locations that bear a relationship with the parent element 14a. By way of the continuing example discussed above, the third level graphic elements 16a and 16b may represent floor plans of the zones of the building represented by the second level graphic element 14a.

The links 24a and 24b are also preferably represented as selectable graphical icons or displays that have a one to one correlation to the third level graphic elements 16a and 16b. Accordingly, when viewing the second level graphic element 14a, the user may select the link 24b to view the third level graphic element 16b.

The third level graphic element 16a includes, or has associated with it, three data links 26a, 26b and 26c. Each of the data links 26a, 26b and 26c is a link to alarm information from a specified source. To this end, each data link 26x may represent a virtual connection to a system device that is capable of generating an alarm. For example, the data link 26a may be associated with alarm information generated by a particular smoke detector, while the data link 26b is associated with alarm information generated by a certain pull station. If the third level graphic element 16a represents a zone or room in the building represented by the upstream graphic element 14a, then the data links 26a, 26b and 26c may suitably correspond to alarm devices physically located within that zone or room.

The links 26a, 26b and 26c, like other links, are also preferably represented as a distinct indicator on the graphic associated with the third level graphic element 16a. The distinct indicator may have an appearance of an icon or other graphical symbol representative of the alarm associated with the link. When the alarm data changes values, the icon may change its appearance accordingly. For example, if a low level alarm condition is indicated by the alarm data associated with the link 26b, the graphic symbol representing the link 26b, or a portion thereof, may blink with a yellow color. If a critical alarm condition is indicated by the same alarm data, then the graphic symbol representing the link 26b or a portion thereof may blink with a red outline. If no alarm condition is indicated by the alarm data, the graphic symbol would not including any blinking portions.

The third level graphic element 16b similarly includes two data links 26d and 26e. As will be discussed below, the third level graphic element 16b is subsequently changed to include another data link 26f. Similar to the alarm links 26a-26e, each of the data links 26d, 26e and 26f is a virtual connection to a distinct alarm generating device.

The third level graphic element 16c also includes two distinct data links 26g and 26h.

Referring now to the other second level graphic 14b, the second level graphic element 14b has two links 24d and 24e. The link 24d associates the second level graphic element 14b with a third level graphic element 16d. Analogous to the third level graphic elements 16a and 16b, the third level graphic element 16d is a child element of the second level graphic element 14b and a descendant of both the second level graphic element 14b and the first level graphic element 12. By way of example, the third level graphic element 16d may represent a floor plan of a zone of the building represented by the second level graphic element 14b.

The third level graphic element 16d includes two data links 26i and 26j. Similar to the data links 26a-26c, each of the links 26i and 26j is a virtual connection to a distinct alarm generating device.

The link 24e is a data link similar to the links 26a, 26b, etc. For example, the data link 24e may be associated with alarm information generated by a smoke sensor, heat sensor or pull station located in the building represented by the second level graphic element 14b. Thus, direct alarm links to alarm generating devices may be included on graphic elements of various levels.

One aspect of the hierarchical graphic system is that each graphic element will display alarm information corresponding to any data link included within any descendant graphic element. For example, if the data link 26e contains values indicative of a high priority alarm, some indication of that alarm would be displayed on the graphics associated with any of the elements 16b, 14a or 12. Thus, if an operator is viewing a graphic of a campus of buildings in the first level graphic element 12, then high priority alarm information from the data link 26e is displayed within the graphic of the campus. Moreover, such priority alarm information is preferably displayed in connection with the graphic icon or element associated with the link 22a, which is upstream from the actual alarm link 26e. Thus, while the first level graphic element 12 may include display icons for the links 22a and 22b, alarm values on alarm link 26e only cause alarm information to be displayed in connection with the displayed icon for the link 22a.

To accomplish the hierarchical display of alarms described above, each graphic element maintains a set of alarm information representative of all alarm oriented data links connected to itself and its descendants. Thus, as shown in FIG. 1, the third graphic element 16a has the associated alarm information set {26a, 26b, 26c}, the second graphic element 14a has the associated alarm information set {26a, 26b, 26c, 26d, 26e} and the first graphic element 12 has the associated alarm information set {26a, 26b, 26c, 26d, 26e, 24e, 26i, 26j}. Moreover, the second level graphic element 14b has the associated alarm information set {24e, 26i, 26j}.

In operation, a suitable graphics program allows a user to display on a computer display any of the graphics. From time to time, alarm messages from the building system are received by the computer. These alarm messages identify an alarm condition on a particular devise or set of devices. When an alarm message (e.g. a value signifying an alarm situation) is received by the computer, it is determined whether the alarm information set of the graphic element currently being displayed includes the corresponding data link. If so, then some graphical or textual indication of the alarm is displayed. Thus, if an alarm message from the device corresponding to the data link 26b is received, and if the user is currently viewing the second level graphic element 14a, then an indication of the alarm would be displayed because the alarm information set of the graphic element 14a includes the link 26b.

In accordance with one aspect of the invention, addition of an alarm-oriented data link to a particular graphic element causes the alarm information sets of all upstream elements (i.e. all direct ancestors) to be automatically updated. For example, if a new alarm link 26f is added to the third level graphic element 16b, then the alarm information set of the graphic element 16b as well as the alarm information sets of its upstream graphic elements 14a and 12 are automatically updated. As a consequence, if an alarm message originates from the device corresponding to the alarm link 26f, then an alarm indication will be displayed if graphics 16b, 14a or 12 are currently being displayed.

Moreover, an addition of a link between two graphic elements may cause an automatic update of alarm information sets. For example, if the link 24c is added between the second level graphic element 14a and the graphic element 16c, then the alarm information sets of 14a and 12 are automatically updated to include references to the alarm links 26g and 26h.

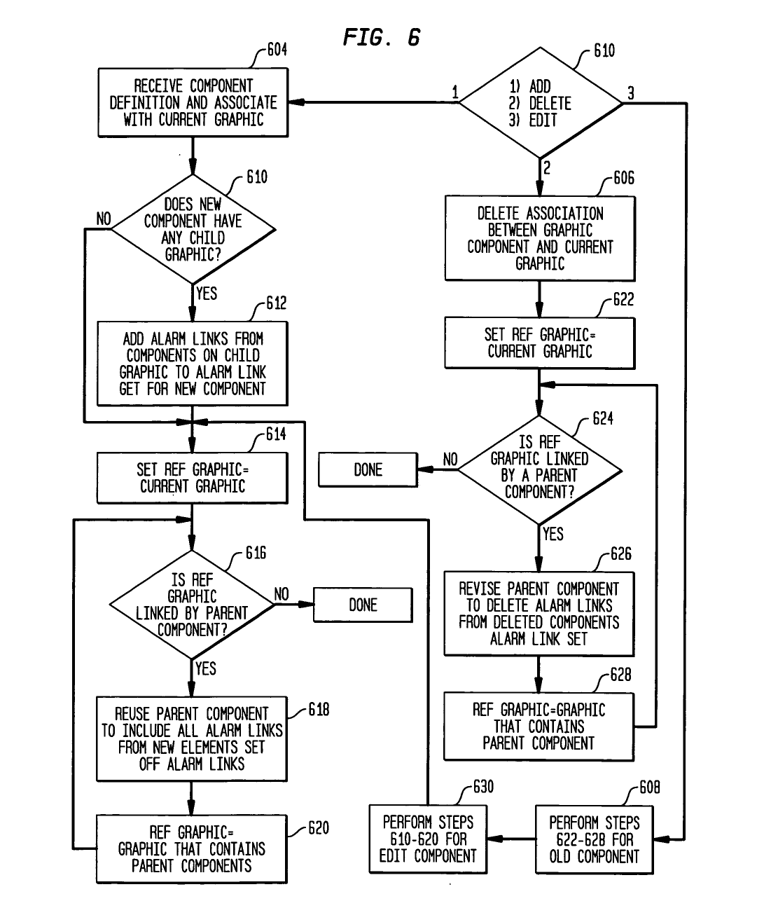

The automatic update may be achieved in software by iteratively traversing the hierarchical tree upward and adding the “new” alarm links information to the information set of every upstream element. Further details regarding exemplary automatic update methods provided below in connection with FIG. 6. It is noted that if one or more data links are removed from a graphic element, such as removing the data link 26f or the link 24c, then the alarm information sets of all upstream graphic elements are updated in converse fashion by removing references to the relevant alarm links from their alarm information sets.

Thus, the above system provides a method of updating a hierarchical graphic system, particularly a hierarchical graphic system in which graphic elements display alarm indicators when an alarm associated with any descendant or downstream graphic element has a value indicating an alarm condition. The present invention automatically updates upstream elements responsive to a change in number of alarm-oriented data links to a particular system graphic element. Thus, as logical links between graphics are made or broken, the upstream graphic elements maintain a current list of downstream alarm-generating links. Moreover, as alarm-oriented data links are added to or subtracted from a graphic element, all upstream elements likewise updated to maintain a current list of downstream alarm-generating links.

As a consequence, a system designer or implementation technician need not painstakingly determine every graphic screen in which a particular alarm should appear in a hierarchical graphical display system. Instead, the appropriate hierarchical graphic elements are automatically updated responsive to any change in the number of downstream alarm-oriented data links.

The system of FIG. 1 may be generalized for use in a fire alarm system, building HVAC system, security system, or even a factory automation system. All such systems create alarms associated with disparate devices for which hierarchical graphical representation may be useful.

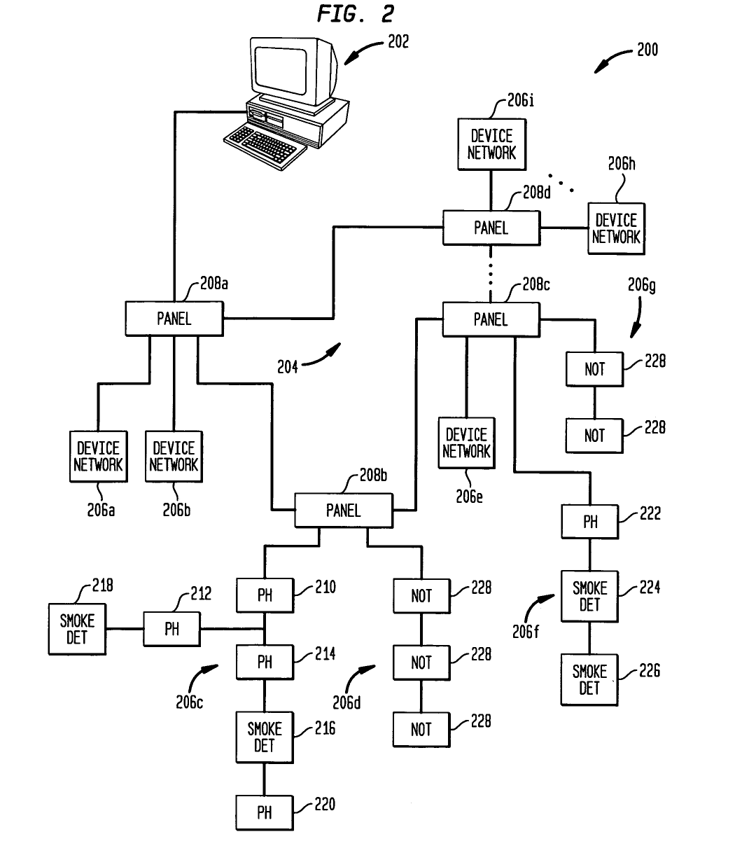

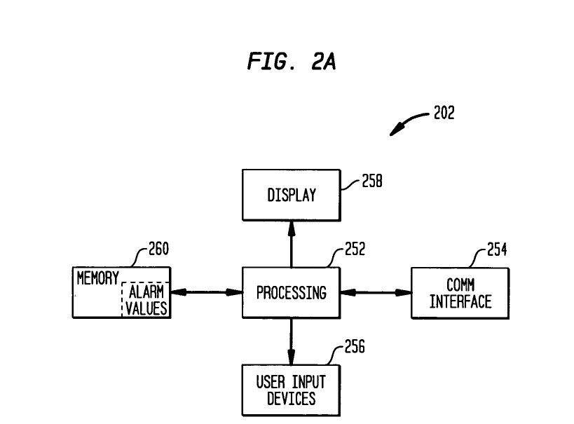

FIGS. 2 through 5 show in further detail an exemplary implementation of the present invention in a fire alarm system. FIG. 2 shows a block diagram of an exemplary fire safety system 200 that incorporates the graphical capabilities of the present invention. The alarm system 200 illustrates a relatively simple example of a fire safety system that includes the main components typical of a fire safety system. However, the embodiment of the invention described in FIGS. 2 through 5 may readily be adapted to fire safety systems of different scales.

Referring to FIG. 2, the fire safety system 200 includes a centralized control station 202, a building network 204, and a plurality of device networks, illustrated by exemplary device networks 206a, 206b, 206c, 206d, 206e, 206f, 206g and 206h. A series of control panels 208a, 208b, 208c and 208d logically and electrically connect the exemplary device networks 206a through 206h to the building network 204. The control panels 208a-208d are connected to each other and the control station 202 via the building network 204.

Referring now to FIG. 2a, the control station 202 is implemented as a general purpose computer. To this end, the control station 202 includes a processing circuit 252, a communication interface 254, a set of user input devices 256, a display 258, and memory 260. The control station 202 may further include a plurality of other devices, such as modems, disk arrays, printers, scanners and other devices typically employed in connection with multipurpose computers. The processing circuit 252 may be a circuit that includes any suitable Pentium-class microprocessor available from Intel, or any comparably powered microprocessor. The display 258 may be any suitable display, including a CRT display, LCD display, or plasma screen display. The input devices 256 may suitably include pointing devices, keyboards, microphones or the like.

The memory 260, which may include many types of memory devices associated with general purpose computers, including random access memory, permanent or removable disks or tapes and the like, maintains a table or other data structure of alarm messages received from various fire safety devices in the system 200 of FIG. 2. In the embodiment described herein, the data structure of alarm messages contains, among other things, the identity of the fire safety device that generated the alarm message and the type (e.g. priority level) of the alarm. The memory 260 also maintains information regarding the structure of the fire safety system 200.

In addition, the memory 260 may receive and store other system variables. In particular, certain devices (fire safety devices, HVAC devices or other devices) generate measured values or sensed values such as temperature, battery charge, etc. These values are stored as system variables. One or more system variables may be associated with each device. Thus, as non-alarm information is generated by various devices, such information is mapped to system variables. Details regarding system variables are outside the scope of the present invention. In general, however, the memory 260 may be employed to store some or all of such system variables, at least temporarily.

The control station 202 generally provides centralized monitoring and control of various elements on the system 200. While some of the control of the devices of the fire safety system 200 is necessarily localized, the control station nevertheless 202 performs supervisory control and monitoring functions. Such functions of fire safety systems having a framework similar to that of the fire safety system 200 are known in the art. In addition, however, the control station 202 employs a hierarchical graphical alarm system that enables the user to display hierarchical graphical maps or floor plans of the building in which the fire safety system 204 is implemented.

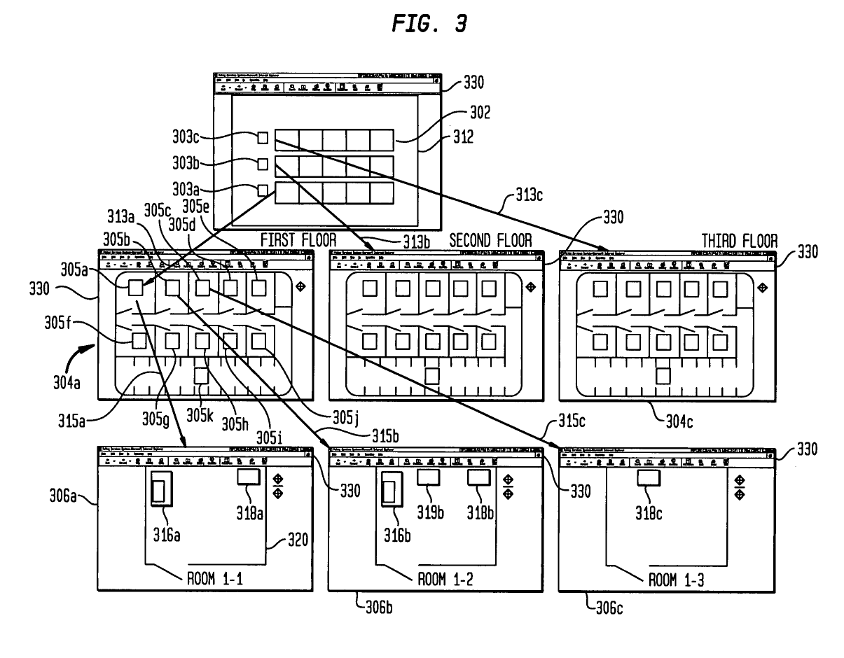

By way of example, FIG. 3 shows sample screen graphics illustrating the hierarchical graphic alarm system. A top level graphic 302 illustrates a building diagram showing the three floors of the building, three middle level graphics 304a, 304b and 304c illustrate floor plans of each of the three floors of the building, and three lower level graphics 306a, 306b and 306c illustrate three rooms of one of the floors corresponding to the middle level graphic 304a. Ideally, room level graphics are available for many or all of the rooms of all three floors of the building. Further detail regarding the display and control of the graphic alarm system is discussed further below in connection with FIG. 3.

Referring again to FIG. 2, each of the device networks 206a-206i is a set of interconnected fire safety devices, which may include pull stations, smoke detectors, notification devices and the like. Typically, fire safety devices may be categorized as detection devices, notification devices, and control devices. Detection devices, such as pull stations and smoke detectors, detect conditions indicative of a possible fire emergency. Notification devices, such as strobe “fire” lights, audible alarms, and voice notification devices, provide human perceptible indications that a fire emergency is present. Control devices may include devices that limit elevator operation, or control door locks in response to a fire emergency.

By way of example, the device network 206c is a network that is comprised primarily of detection devices. To this end, the device network 206c includes four pull stations 210, 212, 214, 220 and two smoke detectors 216, 218. The devices are connected to each other and to the control panel 208b via a digital communication network. By way of example, the communication network may suitably be a proprietary or open protocol short range data network, which are well known in the art. The pull stations 210, 212, 214, 220 and the smoke detectors 216, 218 are dispersed throughout a particular floor or zone of a building.

The pull stations 210, 212, 214, 220 are configured to generate a signal indicating an alarm condition if the mechanical handle (or other actuator) has been physically manipulated by a person to indicate a fire alarm. If a pull station actuator has been manipulated, then the relevant pull station provides an alarm message to the control panel 208b, the alarm message including the pull station's identity. The control panel 208b thereafter communicates the alarm message including identity information to the control station 202 using the communication network 204. The control station 202 stores the alarm message in the table in the memory 260. The control station 202 furthermore generates a general alarm and/or updates the alarm graphics as will be discussed below.

Similar to the pull stations 210, 212, 214, 220, the smoke detectors 216, 218 are configured to generate a signal indicating an alarm condition responsive to the detection of smoke. The smoke detector may also be able to generate information regarding its condition, for example, whether maintenance is required. Smoke detectors having such capabilities are well known. In the network 206c, the smoke detectors 216 generate the alarm condition signal as digital information signals that include device identification information. If a smoke detector detects smoke, the relevant smoke detector notifies the control panel 208b of the alarm condition and of its identity. The control panel 208 thereafter communicates the alarm message including device identity information to the control station 202 using the communication network 204. As above, the control station 202 stores the alarm message in the table in memory 260 and then causes appropriate alarm notification and updates the graphics.

It is noted that different device networks 206x may have different levels of communication capabilities. For example, while the network 206c features digital communications that allow the devices 210, 212, 214, 216, 218 and 220 to be individually addressed, other device networks, for example, the device network 206f, are analog circuits that merely communicate basic alarm information using analog signals. Specifically, the device network 206f in the embodiment described herein consists of a common two wire analog circuit to which are connected a pull station 222 and two smoke detectors 224, 226. The network 206f terminates in the fire control panel 208c, which controls the various fire safety devices of another floor or zone of the campus. Analogous to the network 206c, the devices 222, 224 and 226 of the network 206f are dispersed throughout different locations of the relevant floor or building.

In general, the fire control panel 208c obtains fire safety information from the devices 222, 224 and 226 based on detected characteristics of the two wire analog circuit. For example, if no alarm conditions are present (no fire or equipment malfunction), then the fire control panel 208c detects a predetermined impedance or signal level on the line. If, however, a fire condition is detected by one of the devices 222, 224 or 226, then the corresponding device shorts the two wire analog circuit, changing its impedance. In such a case, the fire control panel 208c detects the impedance change, generates an appropriate alarm message, and transmits the alarm message to the control station 202. If precise identification of the device that detected the condition cannot be determined in the analog device networks 206f, then the alarm message generated by the fire control panel 208c would merely provide data as to the alarm type and the identity of the device network 206f in which it was detected.

The device network 206d represents an example of a notification device network. The notification device network is comprised of three notification devices 228. These devices 228 are also dispersed throughout a floor or zone of a building. The notification devices 228 are configured to receive alarm notification signals from the control panel 208b and generate a visual or audible signal responsive thereto. The notification devices 228, may for example, be flashing strobes, or combined strobes and audible horns. It is noted that the notification devices 228 need not be individually addressable, but instead may simply be interconnected by an analog signal network. For example, the notification devices 228 may generate audible or visual alarms responsive to the presence of a 24 volt analog signal, or responsive to certain signals modulated on an analog carrier signal.

It is noted that the device network 206c and the device network 206d are preferably dispersed throughout the same general area, for example, on the same floor or zone of the same building. To this end, it is noted that each of the control panels 208a-208d is a building level, floor level or zone level controller to which individual device networks 206x located in that building, floor or zone may be connected.

As discussed above, the control station 202 executes a graphics program that, among other things, provides graphic displays of the facility at varying zoom levels. Referring again to FIG. 3, the control station 202 is capable of displaying a building level graphic 302, floor level graphics 304a-304c, and room level graphics 306a-306c.

It will be noted that in the discussion of the embodiment described herein, the phrase “graphic” shall have its ordinary meaning as would be known to those of ordinary skill in the art, including but not limited to a set of associated images which can include static graphical information, incorporated text information, and active or dynamic graphical components. A graphic need not fill an entire viewing area of a computer display, as is known in the art.

In general, each graphic includes background static information showing context, and one or more active graphic components. An active graphic component is a graphic component or object that is dynamic or interactive. For example, an active graphic component may be a selectable icon, a device that changes appearance based on some value, or a combination of both. For example, the top level graphic 302 includes a static background image 312 of the building and several active graphic components 303a-303c, which are discussed further below.

Active graphic components in the embodiment described herein typically include one or more types of links. Such types of links include links to other graphics and/or alarm links to system alarm generators. Other links may include links to system devices that do not generate alarms, links to static text or other graphics. For example, as will be discussed below in further detail, the graphic component 303a includes a link 313a to the graphic 304a, and the graphic component 318a includes an alarm link to the smoke detector 216.

It will be appreciated that links are merely logical associations to system data that may take many forms, even within the same system. As discussed above, in the embodiment described herein, an alarm link is a link to alarm information regarding a particular alarm generating device.

To this end, it is noted that most if not all alarms present in the system 200 are associated with a device or point in the system such as, for example, a particular smoke detector, a field panel, a pull station, or a temperature sensor. A graphic component having an alarm link to a particular device may receive alarm information regarding that device in a number of ways. The method in which alarm information is received can depend upon the form in which the data is available. For example, alarm information may be present in an update message generated by the device itself, or stored within a point status table, or stored within an alarm status table. The precise method in which alarm information from particular system devices are provided to “linked” graphical components will vary from system to system, and the desirability of one or more particular methods of “linking” alarm generating devices to graphical components will be readily apparent to those of ordinary skill in the art based upon their implementation needs.

A graphic may have several graphics components located therein. Any graphic component located within a graphic is said to be contained in or included in the graphic. As used herein, both graphics and their graphic components can constitute graphic elements.

In the exemplary embodiment described herein, the graphics program executed by the control station 202 is also capable of displaying sensor data and other data associated with other building systems, such as an HVAC system, not shown. To this end, certain graphic components contain data links to system devices that convey non-alarm measurement or status information. For example, a graphic component may have a data link to a device that generates one or more HVAC system values, such as temperature, air pressure, air flow, or the like. For example, the graphic component 316a, discussed below, has a data link to a particular temperature sensor within the HVAC system. Information representative of the temperature sensed by the sensor is displayed in the connection with the graphic component 316a, which in included in the room level graphic 306a. While the system described herein displays non-alarm system data as well as alarm information in the same graphics, it will be appreciated that many of the advantages of the present invention may be obtained in a system dedicated solely to alarm information. It will further be appreciated that fire alarm devices such as smoke detectors may also generate non-alarm data.

Referring again generally to the hierarchical graphic structure, the graphic 302 includes a background graphic image 312 in the form of an image of a three floor building. The graphics page 302 further includes graphic components 303a, 303b, 303c in the form of user-selectable graphical icons. The graphic component 303a is disposed next to the image of the bottom or first floor of the building in the background graphic image 312, and includes a link 313a to the graphic 304a, which as discussed below contains an image of the floor plan of the first floor of the building. The graphic component 303a furthermore includes a set of alarm links, discussed further below. In general, the set of alarm links identifies a set of system devices for which an alarm notification will be displayed in connection with the component 303a. In general, any graphic component 303a includes, but is not limited to, any alarm link that is within the set of alarm links for any descendant graphic component.

The graphical component 303b is disposed next to the image of the second or middle floor of the building in the image 312, and includes a link 313b to the graphic 304a, which contains an image of the floor plan of the second floor. The graphic component 303b furthermore contains its own set of alarm links including any links in the set of alarm links of its descendant graphic components.

The graphic component 303c is disposed next to the image of the third or top floor of the building in the image 312, and includes a link 313c to the graphic 304c, which contains an image of the floor plan of the top floor. The graphic component 303c also includes an analogous set of alarm links.

Each of the links 313a, 313b and 313c defines a logical path between the graphic components 303a, 303b and 303c and their respective descendant graphics 304a, 304b, and 304c respectively. More specifically, if the graphic 302 is displayed and the user selects the graphic component icon 303a, then the control station 202 logically traverses the link 313a to display the middle level graphic 304a. If instead the user selects the graphic component icon 303b, then the control station 202 logically traverses link 313b to display the middle level graphic 304b. Finally, if the user selects the graphic component icon 303c, then the control station 202 logically traverses the link 313c to display the middle level graphic 304c. Software capable of carry out such operations is well known to those of ordinary skill in the art.

The middle level graphic 304a is representative of the lower floor of the building of the graphic 302. The graphic 304a includes a background image 318 and a plurality of graphic components 305a-305k. Similar to the graphic components 303a-303c, the graphic components 305a-305k comprise user selectable icons. The background image 318 depicts an image of a floor plan of the lower floor of the building of graphic 302. Each of the graphic components 305a-305k is located within an area or room of the floor plan of the background image 318, and is linked to a child graphic depicting in further detail that same area or room. By way of example, graphic components 305a, 305b and 305c are shown as having links 315a, 315b and 315c respectively to room graphics 306a, 306b and 306c. The graphic components 305a-305k are considered to be descendant graphic components of the graphic component 303a, as well as the graphic 304a.

The middle level graphics 304b and 304c are similar graphics pages representative of the other two floors of the building. Both graphics 304b and 304c include a background image and a plurality of graphic components analogous in function, appearance and operation to background image 318 and the graphic components 305x. However, it will be appreciated that if one of the actual building floors has a different floor plan, then the background image of the corresponding graphics page would be different to reflect the actual floor plan. Nevertheless, in the exemplary building represented by the graphics of FIG. 3, the floor plans are effectively identical on all three floors.

The graphic 306a includes a graphic image 320 illustrative of a room, and includes graphic components 316a and 318a. The graphic components 316a and 318a are descendant graphic components of the graphic component 305a.

The graphic component 316a is an active control displaying information from a temperature sensor, not shown, located in the room represented by the graphic 320. To this end, the graphic component 316a has a data link to temperature information from a particular temperature sensor, not shown. Ideally, the temperature sensor that provides temperature data is physically located within the room depicted by the graphic 306a.

In any event, it can be seen that the graphical system shown in FIG. 3 may display data from other systems, such as an HVAC system, not shown, in addition to the alarm indications from the fire alarm system 200. Such other systems also use data networks, not shown, to communicate their system data (and alarms) to the control station 202. For example, the movement of data between the temperature sensor and the processing circuit 252 (see FIG. 2a) is carried out by the HVAC control system, not shown, but which is connected to the control station 202.

The graphic component 318a does not contain any link to additional graphics, but includes a single alarm link to the smoke detector 216 (see FIG. 2), which is located in the room represented by the graphic 320. The graphic component 318a may also include a datalink to (non-alarm) system data associated with the smoke detector 216. For example, the smoke detector 216 may provide a sensitivity reading from time to time. In such a case, the information displayed in the graphic component 318b may incorporate the present value of the smoked detector sensitivity reading. It is furthermore noted that the data link and the alarm link may merely take the form of a routine that causes the graphic component to receive all updates from the smoke detector 216, whether alarm or non-alarm data. The displayed information may also include static identification or location information, which is not generally variable.

Thus, it will be appreciated that some graphic components, such as components 316a and 318a, have both system data links and alarm links, while others, such as components 303a and 305a, have both descendant graphic links and alarm links. In all of the above-described graphic components, the processing circuit 252 will cause a notification of an alarm to be displayed in connection with the graphic component if an alarm message is received that contains the identity of a system device identified on the set of alarm links for the graphic component. Further detail regarding the set of alarm links for the graphic components is provided below in connection with tables 1 and 2.

It will be appreciated that in alternative embodiments, HVAC devices such as the temperature sensor represented by the graphic component 316a may also generate alarm messages for a variety of purposes. The present invention may readily be adapted to also display such alarm messages using the hierarchical graphic method described herein.

Referring again to the general description of FIG. 3, the graphic 306b is a graphic page similar to the graphic 306a, and includes graphic components 316b, 318b and 319b. The graphic component 316b is an active control displaying information from a temperature sensor, not shown, located in the room represented by the graphic 306b. Thus, the graphic component 316b is linked to the system variable(s) associated with that temperature sensor. The graphic component 318b includes an alarm link to the smoke detector 218 of FIG. 2, which located in the room represented by the graphic 306b. Thus, the graphic component 318b further includes a data link to the smoke detector, which contains non-alarm information generated by the smoke detector 218. The graphic component 319b is an active control displaying information relating to a fire safety device in the form of the pull station 212 of FIG. 2, and includes an alarm and data link to the pull station 212.

The graphic 306c is also similar to the graphic 306a, and includes a graphic component 318c. The graphic component 318c is an active control displaying information from a fire safety device in the form of the pull station 214 of FIG. 2, which located in the room represented by the graphic 306c. To this end, the graphic component 318c includes an alarm link to the pull station 214.

As discussed above, each graphic component on any of the graphics has associated with it a set of alarm links, each alarm link associated with an alarm generating device. If an alarm message is received from any of these devices, an alarm indication will be displayed in connection with that graphic component. In the system described herein, the set of alarm links for each graphic component necessarily contains all of the alarm links from the set of alarm links for all of its descendant graphic components. Applying such rules to the graphic components shown in FIG. 3, Table 1 below shows exemplary sets of alarm links associated with many of the graphic components in FIG. 3.

TABLE 1

| Component | Alarm Link Set |
|---|---|
| 318a | 216 |
| 318b | 218 |
| 319b | 212 |
| 318c | 214 |
| 305a | 216 |
| 305b | 218, 212 |
| 305c | 214 |
| 303a | 216, 218, 214, 212, . . . } |

It will be appreciated that the alarm link set of component 303a further includes any alarm links from the sets of alarm links in its other descendant graphic components 305d-305k. As will be discussed below, when any graphic 302, 304a-304c or 306a-306c is displayed, the control station 202 will display alarm information for any graphic component for which an active alarm message exists corresponding to one of the devices on its set of alarm links.

In the exemplary embodiment described herein, the alarm link set of each component preferably further includes information identifying the root component for each alarm link. The root component is the graphic component that is directly linked to the device generating the alarm, as opposed to being linked through a descendant graphic. An alarm link of a graphic component is direct if no descendant graphic component includes that alarm link. An alarm link is not direct if a descendant graphic component also includes the link.

Such information is shown in Table 2, which represents the alarm links shown in Table 1 with the additional information identifying the root component information.

TABLE 2

| Component | Alarm Identifier Set (Root Component) |
|---|---|
| 318a | 216(318a) |
| 318b | 218(318b) |
| 319b | 212(319b) |
| 318c | 214(318c) |
| 305a | 216(318a) |
| 305b | 218(318b), 212(319b) |
| 303a | 216(318a), 218(318b), 214(319b), 212(318c), . . . |

As will be discussed further below, the root component information facilitates the ability to jump directly to the lowest graphic that includes the component for which an alarm message is received.

In addition to the hierarchical graphic alarm system described above, the control station 202 may also perform other complementary alarm display functions. In particular, in accordance with fire safety standards, at least some indication of certain alarms must be made audible and/or visible regardless of which graphics are being displayed by the control station 202. Thus, while the hierarchical graphical alarm system described herein may or may not display a certain alarm depending on whether it is downstream of the current graphic, another system should provide an audible or visible alarm regardless.

Accordingly, the hierarchical graphic alarm system of the present invention may be used in conjunction with another alarm notification system that provides universal notification of all alarms. The other alarm system may indeed constitute the primary alarm notification system for fire safety code purposes. Such a primary alarm notification system may or may not be implemented through the control station computer 202.

In the embodiment described herein, the primary alarm notification system is implemented through the control station 202. To this end, it is noted that the control station 202 also displays an overall alarm notification bar 330 which is perpetually displayed, regardless of which graphics page is being displayed. Referring to FIG. 3, the notification bar 330 in the exemplary embodiment described herein is displayed by the control station 202 above each of the graphics pages 302, 304a-304c and 306a-306c. The notification bar 330 provides at least rudimentary information regarding priority alarms regardless of which graphic components are being displayed. In this manner, the operator may be at least notified of an active alarm even if it is not associated with a currently-viewed graphic component(s) or a descendant thereof.

By way of example, if the operator is viewing the graphic 304c and a smoke alarm message is generated by the smoke detector 216, the control station 202 would not display an alarm indication on the graphic 304c (at least in connection with the floor plan image) because the smoke detector 216 is not linked to any graphic component on the graphic 304c. In such a case, however, the control station 202 independently displays the alarm indication on the notification bar 330.

The advantage of providing the alarm graphic system of the invention in addition to the primary notification bar 330 is that the alarm graphic system provides an interactive, intuitive display of relative locations of alarms in a large fire safety system (or HVAC or other building system), while the notification bar 330 provides overall notification of any serious alarms. Thus, if the notification bar 330 indicates one or more serious alarms, the user may use the alarm graphic system described herein to navigate between the various zoom level of graphics to assess the number, location, severity, and distribution of alarms. Moreover, in the case of non-emergency alarms, the operator may methodically navigate through the various levels of graphics to determine the location and quantity of alarm conditions. Such information may be used to diagnose possible equipment failures, power loss, or other maintenance issues.

It will also be appreciated that if the graphic alarm system of the present invention is employed solely for non-fire safety systems (e.g. HVAC alarm systems), then no other primary notification graphic alarm system would be necessary.

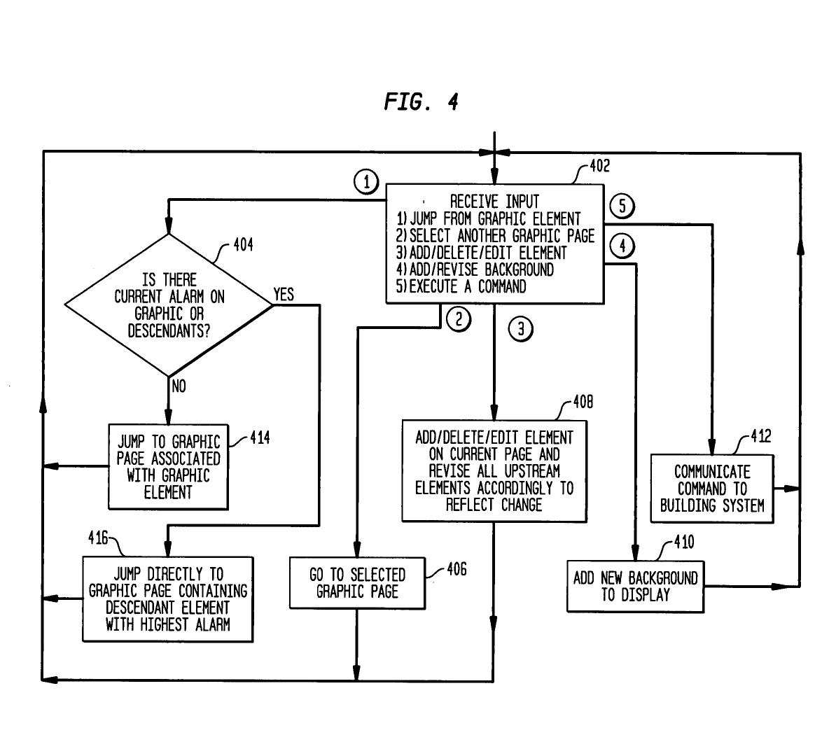

FIGS. 4-6 show in further detail the operation of the control station 202 in executing the alarm graphic system discussed above. Prior to discussion of FIGS. 4-6, however, a brief description of an exemplary operation of the fire safety system of FIG. 2 and the corresponding update of the exemplary graphics shown in FIG. 3 is provided.

Referring now generally to FIGS. 2, 2a and 3, a first exemplary operation is described in which the control station 202 is displaying the top level graphic 302 on the computer display 258, and smoke is detected by the smoke detector 218.

Initially, the smoke detector 218 generates an alarm message signal that includes information identifying itself and the alarm condition that has been detected. The smoke detector 218 communicates the alarm message signal to the control panel 208b. The control panel 208b then typically causes the alarm notification devices (e.g. 206d) to generate an audible and/or visible alarm. The details regarding appropriate notification procedures in a fire safety network having the general configuration of the system 200 are well known in the art. The details of such procedures are outside the scope of the present invention. The control panel 208b also communicates the alarm message over the network 204 to the control station 202.

Referring specifically to FIG. 2a, the communication interface 254 receives the alarm message and passes the signal to the processing circuit 252. Among other things, the processing circuit 252 updates the display 260 such that the alarm notification bar 330 (See FIG. 3) includes an indication of the alarm condition detected by the smoke detector 218.

The processing circuit 252 also further determines whether an update to the displayed graphic 302 is necessary. To this end, the processing circuit 252 determines whether the new alarm message corresponds to the sets of alarm links associated with the graphic components 303a, 303b and 303c of the currently displayed graphic 302. In the exemplary operation described herein, the processing circuit 252 determines that the set of alarm links for the graphic component 303a includes the device 218 (See Table 1, above).

To this end, the processing circuit 252 reviews the alarm link set of each displayed graphic component to determine if the device that generated the recently received alarm message is contained in any of the alarm link sets. If so, the new alarm information is displayed. The exact update procedure including comparison of alarm link sets to received alarm message information may take many forms, as discussed further above.

To display alarm information, the relevant graphic component may change color or have a colored blinking outline. In the exemplary operation described herein, the graphic component 303a would have a blinking yellow, orange or red outline, depending on the severity of the alarm.

FIG. 4 shows an exemplary set of operations of the processing circuit 252 in further detail in displaying the alarm graphics in the general case. The set of operations are in the form of a flow diagram. The operations of FIG. 4 do not address the update and display of the notification bar 330 of FIG. 3. An exemplary description of the display of a notification bar such as the notification bar 330 is described in my copending application Attorney Docket No. 1867-0018, which is filed on even date herewith and incorporated herein by reference.

In step 402, the processing circuit 252 awaits to receive a command input from the user. The user may select from a number of commands. By way of example, the selectable commands include “jump from graphic component”, “select another graphic page”, “add/delete/edit graphic component”, “add/revise background”, “executed a command”. The operator may enter a selection using the input devices 256 in any suitable well known manner.

If “jump from graphic component” is selected, then the processing circuit 252 proceeds to step 404. If “select another graphic page” is selected, then the processing circuit 252 proceeds to step 406. If “add/delete/edit graphic component” is selected, then the processing circuit 252 proceeds to step 408. If “add/revise background” is selected, the processing circuit 252 proceeds to step 410. If “execute a command” is selected, then the processing circuit 252 proceeds to step 412.

Jump from Graphic Component

To arrive at step 404, the user has selected in step 402 to jump from a graphic component displayed on a current graphic page. To this end, the selected graphic component must be a graphic component that includes a link to another graphic. By way of example, if the graphic 304a is currently being displayed, the operator may use a pointing device to move a cursor over the graphic component 305c to select to jump from that graphic component to its linked graphic 306c.

In step 404, the processing circuit 252 first determines whether the selected graphic component also has an active alarm indication. An active alarm indication will be present if an active alarm message exists for any system device identified in the set of alarm links for the selected graphic component. If the selected graphic component does not have an active alarm indication, then the processing circuit 252 proceeds to step 414. In step 414, the processing circuit 252 traverses the link attached to the selected component and displays the appropriate child graphic.

For example, if a jump from the component 303a is selected and it is determined that there are no active alarm indications associated with the component 303a, then the processing circuit 252 traverses the link 313a and displays the graphic 304a.

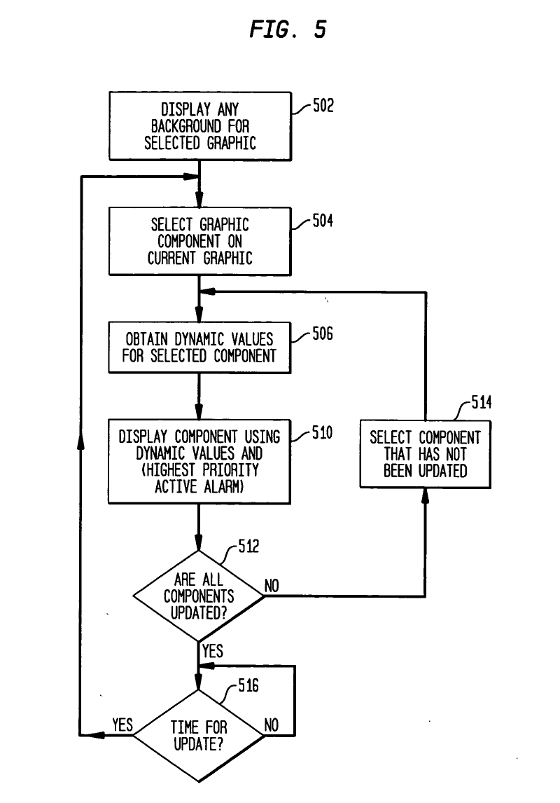

Details regarding the display of a newly selected (or jumped to) graphic page is generally shown in FIG. 5 and discussed further below. After step 414, the processing circuit 252 awaits a new command in step 402 while the newly selected graphic is displayed.

If, however, it is determined in step 404 that the selected graphic component has an active alarm indication, then the processing circuit 252 executes step 416. In step 416, the processing circuit 252 jumps directly to the graphic that contains the root graphic component that is directly linked to the system device having an active alarm message. The root graphic component, as discussed above, is the lowest graphic component in the hierarchy to contain the alarm link. (See, e.g. Table 2).

The processing circuit 252 thus in step 416 identifies the graphic that includes the root graphic component and then displays the identified graphic. For example, if the graphic 302 is displayed, and the graphic component 303a has an active alarm indication because the pull station 214 associated with the descendant component 318c has an active alarm message, then the processing circuit 252 in step 416 jumps directly to display the graphic 306c, instead of the immediately linked graphic 304a.

As mentioned previously, details regarding the display of a newly selected (or jumped to) graphic is generally shown in FIG. 5 and discussed further below. After step 416, the processing circuit 252 returns to step 402 to await the next command while the newly selected graphic is displayed.

Thus, the above steps illustrate a feature of this embodiment of the invention in which an operator is automatically linked or taken to the graphic that contains the root graphic component for the alarm link for the device that has an active alarm message. In an emergency, such operation allows the operator to quickly view visual details of the device that generated the alarm message. The intermediate descendant graphics are bypassed.

In an alternative, step 416 could provide the operator the option of either jumping directly to the graphic that contains the root graphic component, or instead jumping to the next linked graphic, as per step 414. Such an alternative provides greater flexibility by providing the user the option of bypassing intermediate descendant graphics.

Select Another Graphic

Referring again to step 402, the processing circuit 252 allows the operator to select any other graphic in the system, and not just the descendant graphic of a selected graphic components on the currently displayed page. For example, if the graphic 304a is currently displayed, then the processing circuit 252 allows the user in step 402 to specify any other graphic, and not just the graphics linked to the displayed components 305a-305k. To this end, the processing circuit 252 causes the display 258 to provide a pull down menu or the like showing all available graphics.

If the user selects another graphic via this method in step 402, then the processing circuit executes step 406. In step 406, the processing circuit 252 causes the selected graphic to be displayed, including the graphic components contained therein. See discussion of FIG. 5, further below for a more detailed description of the display of a graphic. After step 406, the processing circuit 252 returns to step 402.

Add/Delete/Edit Graphic Component

Referring again to step 402, the processing circuit 252 allows the operator to add, delete or edit a graphic component on the currently displayed graphic. For example, consider a system in which a new pull station is added. The operator may (and should) elect to add a graphic component having an alarm link to the newly added pull station. In another example, the operator may elect to delete a graphic component such as the graphic component 318a. Such a deletion may be desired if the associated smoke detector 216 is decommissioned.

Edits, additions and/or deletions of components may also occur if multiple graphics are combined into a single graphic. For example, consider a situation in which the room graphics 306b and 306c are combined into a single new graphic representing both rooms. In such a case, the parent graphic component 305c may be deleted and the parent graphic component 305b may be edited to contain a link to the new combined graphic. Thus, the user may select “add/delete/edit graphic component” for a variety of reasons.

If the user selects “add/delete/edit graphic component” in step 402, then the processing circuit executes step 408. In step 408, the processing circuit 252 performs the desired operation and then automatically updates the relevant ascendant graphic components to ensure that the alarm link sets of each graphic component includes the alarm link sets of its descendant graphic components. In particular, adding, removing, and editing a graphic component can change the alarm link relationships in the hierarchy. Accordingly, the alarm link sets of any affected graphic components must be revised so that the condition that each graphic component includes the alarm links in the sets of all of its descendant graphic components continues to be satisfied. In accordance with one aspect of the present invention, such revision of the alarm link sets is carried out automatically. See discussion of FIG. 6, further below for a more detailed description of the operations involved in adding, deleting and editing graphic components, and updating the alarm identification sets accordingly.

After step 408, the processing circuit 252 returns to step 402.

Add/Revise Background

Referring again to step 402, the processing circuit 252 allows the operator to add or revise a background image on the currently displayed graphic. For example, if the operator desires to create a new graphic, the operator may first elect to add a background image representative of the area or location being represented.

Accordingly, if the user selects “add or revise background” in step 402, then the processing circuit executes step 410. In step 408, the processing circuit 252 allows the user to add a background image to the current page, using drop and drag interactive techniques. To this end, a library of background images may be defined. Moreover, new background images for such a library may be developed in any number of ways, including using graphics development tools available from MicroGrafx.

In step 408, the operator preferably selects and places a background image from such a pre-existing library. Various other elements may be added or removed from the overall background image if desired. Details regarding the creation and manipulation of background images is outside the scope of the present invention, and various suitable methods and techniques would be known to those of ordinary skill in the art.

After step 410, the processing circuit 252 returns to step 402, displaying the current graphic with the new (or revised) background image.

Execute a Command

Referring again to step 402, the processing circuit 252 allows the operator to execute other commands, including those associated with the HVAC system. In particular, as discussed above, the control station 202 may suitably also be employed to control an HVAC system, not shown, located in the same building. The command execution option of step 402 allows the user to provide commands to the HVAC devices. For example, if the graphic component 316a is further linked to a system variable for a set point temperature for the room shown in graphic 306a, the operator may execute a command to define a new set point temperature (similar to setting a thermostat) which is then placed in the appropriate system variable. Thereafter, the processing circuit 252 and/or other HVAC system components would endeavor to change the temperature of the room to the new set point temperature.

Still other commands may allow the user to provide certain notifications through the notification devices of the fire safety system 200 of FIG. 2. For example, the user may execute a command to carry out a fire safety drill. The user may also execute commands to test certain fire safety devices in the system 200.

Accordingly, if the user selects “execute a command” in step 402, and provides the desired command, then the processing circuit executes the command in step 412.

After step 412, the processing circuit 252 returns to step 402.

FIG. 5 shows a diagram of the operations performed by the processing circuit 252 in connection with displaying a graphic in the exemplary graphic system of FIGS. 2 through 6. As discussed above in connection with FIG. 4, the operator may navigate between individual graphics in a number of ways. The operations of FIG. 5 describe the method by which a selected graphic is displayed.

In step 502, the processing circuit 252 causes the display 258 to display any background images associated with the selected graphic. For example, if the graphic 302 is to be displayed, then the processing circuit 252 causes display 258 to display the background building image 314. To this end, the processing circuit 252 retrieves the background image information corresponding to the selected graphic from the memory 260 and then causes the image to be displayed.

Thereafter, in step 504, the processing circuit 252 selects a graphic component to process from those included in the selected graphic. For example, if the graphic 302 is to be displayed, then the processing circuit 252 may select to process the graphic component 303a.

In step 506, the processing circuit 252 obtains any dynamic values for the selected component. Dynamic values may include any values associated with alarm links or data links of the selected graphic component. Typically, only “root” graphic components have (non-alarm) data links to system devices or points. As discussed above, non-alarm data values may include temperature sensor readings, flow readings, or settings for various HVAC, security or fire safety devices. With regard to alarm links, the processing circuit 252 determines if any alarm messages are associated with devices identified on the set of alarm links for the select graphic component. To this end, the processing circuit 252 may review alarm messages stored in the memory 260 and compares the sources of the alarm messages to the set of alarm links for the select graphic component. As discussed above, each alarm message includes information identifying the device that generated the message. For example, referring to Table 2, above, if the step 506 is executed for graphic component 305b of the graphic 304a, then the processing circuit 252 determines whether any active alarm messages in the memory 260 had been generated by the smoke detector 218 or the pull station 212.

In step 510, the processing circuit 252 causes the select graphic component to be rendered in a predetermined position with respect to the background image(s). To this end, the processing circuit 252 renders the image using the static content for the graphic component while applying predefined rules to configure the graphic to include dynamic content obtained in step 506. Static content for each graphic component may suitably be stored in a database in the memory 260 or external to the control station 202.

For example, if the graphic component corresponds to a temperature sensor, the static content may be the shell of a temperature meter gauge, while a “movable” dynamic bar graphic image may be used to indicate the dynamic value of the temperature as stored in the corresponding system variable. Graphic components for fire safety devices such as pull handles and smoke detectors, typically have little or no dynamic information. Similarly, there is typically no dynamic information for graphic components that merely contain links to child graphics such as, for example, the components 303a-303c.

With regard to any relevant alarm messages, the processing circuit 252 in the embodiment described herein displays an indication of the highest level or highest priority alarm identified in step 506. Thus, if multiple alarm messages have been received for devices identified in the set of alarm links for the current graphic component, then the processing circuit 252 causes an indication of only the highest priority alarm message.

Thereafter, in step 512, the processing circuit 252 determines whether all of the graphic components in the current graphic have been processed. If not, then the processing circuit 252 selects another graphic component (that has not yet been processed) in step 514 and returns to step 506.

If, however, all of the graphic components on the current graphic have been processed, then the processing circuit 252 in step 516 awaits the next update event. In particular, in step 516, the processing circuit 252 determines whether it is time for another update to the graphic components. Updates may be carried out on a periodic basis, upon receipt of an alarm message, or a combination of both. If it is time for another update, then the processing circuit 252 returns to step 504. If not, then the processing circuit 252 remains at step 516.

Thus, the above steps illustrate the sequence of graphically rendering a graphic that includes one or more graphic components. For each graphical component, the graphical component is rendered using current system variable values, if the graphic component is linked to any system variables, and using current alarm messages, if the graphic component is linked to any devices that have active alarm messages in the memory 260.

FIG. 6 shows in further detail the “add/delete/edit graphic component” operation of step 408 of FIG. 4. The operations of FIG. 6 illustrate the method in which automatic updates to the sets of alarm links are carried out in the hierarchical graphic structure.

First, in step 602, the processing circuit 252 determines whether a selection is made to add, delete or edit a graphic component. If the operator has selected to add a graphic component, then the processing circuit 252 proceeds to step 604. If the operator has selected to delete a graphic component, then the processing circuit 252 proceeds to step 606. If the operator has selected to edit a graphic component, then the processing circuit 252 proceeds to step 608.

In step 604 (add component), the processing circuit 252 receives and stores the component definition and adds an association between the newly-defined component and the current graphic. In defining a new graphic component, the operator may add alarm links, links to system variables, and/or links to child graphics. Any added alarm links constitute direct alarm links and are included in the set of alarm links for the new graphic component.

The operator also identifies the appearance of the graphic. Typically, there is a library of graphic dynamic controls, icons, or other templates from which the appearance may be selected. The processing circuit 252 stores the graphic component information in the memory 260. The processing circuit 252 further stores the association of the graphic component with the current graphic. Thus, if the display 258 is displaying the graphic 306c, and a new component is defined, that component is associated with the graphic 306c and will be displayed whenever the graphic 306c is displayed.

After step 604, the processing circuit 252 proceeds to step 610. In step 610, the processing circuit 252 determines whether the newly-defined graphic component includes a link to a child graphic. If so, then processing circuit 252 proceeds to step 612. If not, then the processing circuit 252 skips to step 614.

In step 612, the processing circuit 252 updates the set of alarm links for the new graphic component. Prior to step 612, the set of alarm links for the new graphic component only included the direct alarm links defined in step 604, if any. In step 612, however, the processing circuit 612 updates the set of alarm links by adding each alarm link contained in the set of alarm links of each child graphic component (i.e. each graphic component contained on the child page that is linked to the new component). As a consequence of step 612, the set of alarm links of the new graphic component contains all alarm links of any of its descendant graphic components.

Steps 614 to 620 operate to update the alarm link sets of any upstream graphic components in light of the newly-defined component. To this end, in step 614, the processing circuit 252 sets a variable REF GRAPHIC equal to the current graphic. Thereafter, in step 616, the processing circuit 252 determines whether REF GRAPHIC is pointed to or linked by a parent graphic component. If so, then the processing circuit proceeds to step 618. If not, then no further updates to alarm link sets are required and the procedure is complete.

In step 618, the processing circuit 252 revises the set of alarm links for the parent graphic component (identified in step 616) to include all alarm links from the set of alarm links for the newly-defined graphic component. Thereafter, the processing circuit 252 proceeds to step 620. In step 620, the processing circuit 252 sets REF GRAPHIC to the graphic that contains the parent graphic component identified in step 616. After step 620, the processing circuit 252 returns to step 616.

Thus, the above steps 614 to 620 iteratively work up the graphic link hierarchy to automatically update all upstream graphic components with alarm links from the set of the newly-defined graphic component.

Referring now to the deletion of a graphic component, in step 606, the processing circuit 252 deletes the association between the current graphic and the selected graphic component. Steps 622-628 describe the process of updating all upstream graphics to remove alarm links from the deleted graphic.

In particular, in step 622, the processing circuit 252 sets a variable REF GRAPHIC equal to the current graphic. Thereafter, in step 624, the processing circuit 252 determines whether REF GRAPHIC is pointed to or linked by a parent graphic component. If so, then the processing circuit proceeds to step 626. If not, then no further updates to alarm link sets are required and the procedure is complete.

In step 626, the processing circuit 252 revises the set of alarm links for the identified parent graphic component to delete any alarm links from the set of alarm links of the deleted graphic component. Thereafter, the processing circuit 252 proceeds to step 628. In step 628, the processing circuit 252 sets REF GRAPHIC to the graphic that contains the parent graphic component identified in step 624. After step 628, the processing circuit 252 returns to step 624.

Analogous to steps 614 to 620, the above described steps 622 to 628 iteratively work up the graphic link hierarchy to automatically update all upstream graphic components by removing alarm links associated with deleted graphic component.

The processing circuit 252 allows editing of a select graphic component to add or remove a direct alarm link, add, remove or change a graphic link, or add or remove a link to a system variable. In the exemplary embodiment described herein, the processing circuit 252 effectively treats an edit to a graphic component as replacing the old component definition with a new component definition. To this end, the processing circuit deletes the pre-edited component definition and adds the edited component definition. Accordingly, in step 608, the processing circuit 252 performs steps 622-628 using the unedited graphic component as the deleted component, and in step 630, performs steps 610-620 using the edited graphic component as the added component.

The above steps 608 and 630 will have the net affect of adding to upstream components any alarm links that have been added to the set of alarm links through editing of the graphic component, and/or removing from upstream components any alarm links that have been removed through editing of the graphic component.

It will be appreciated that the above described embodiments are merely exemplary, and that those of ordinary skill in the art may readily devise their own adaptations and implementations that incorporate the principles of the present invention and fall within the spirit and scope thereof.

We claim:

1. In a graphical display for displaying alarm indications in a system, the graphical display including hierarchical elements, a method comprising:
a) storing a first set of identifiers associated with a graphic element, the graphic element including one or more child elements, a first child element including a second set of identifiers, the set list of identifiers including identifiers corresponding to at least each of the second set of identifiers;
b) receiving a command changing a status of the first child element, the command changing a number of identifiers included in the second set; and
c) automatically updating the first set of identifiers responsive to the command.

2. The method of claim 1 further comprising:
d) displaying graphical information corresponding to the graphic element;
e) obtaining an alarm associated with a first identifier; and
f) displaying a graphical indication of the alarm if the first identifier is associated with the first set of identifiers.

3. The method of claim 2 wherein step d) further comprises displaying a selectable link graphical element corresponding to each of the one or more child elements.

4. The method of claim 1 wherein the graphic element is a child element of a parent graphic element; and wherein step c) further comprises automatically updating a third set of identifiers responsive to the command, the third set of identifiers associated with the parent graphic element.

5. The method of claim 1 wherein the second set of identifiers comprises includes a single identifier associated with an alarm generating device.

6. The method of claim 1 wherein at least one child element further comprises a graphical control element, the graphical control element displaying a sensed value generated by a sensor device.

7. The method of claim 2 wherein in d) further comprises displaying graphical information corresponding to a plurality of graphic elements including the graphical element.

8. In a graphical display for displaying alarm indications in a system, the graphical display including hierarchical elements, a plurality of elements having at least one upstream element and at least one downstream element, a method comprising:
a) associating with each element alarm information associated with all downstream elements;
b) obtaining input defining a change in alarm information associated with a first element; and
c) automatically updating the alarm information associated with a second element upstream of the first element.

9. The method of claim 8 wherein c) further comprises automatically updating a third element upstream of the second element responsive to the obtained input.

10. The method of claim 8 wherein step b) further comprises changing an association between the first element and a child element downstream of the first element.

11. The method of claim 8 wherein the first element is a graphic page, and wherein step b) further comprises changing a number of graphic-control elements on the graphic page, the graphic control elements each having an alarm link.

12. The method of claim 11 wherein at least one of the graphic control elements displays a sensed value generated by a sensor device.

13. The method of claim 8 wherein step b) further comprises adding alarm information and further comprising:
d) displaying a graphic associated with the second element;
e) obtaining an alarm condition corresponding to the added alarm information stored for the second element;
f) providing an indication of the alarm in the graphic associated with the second element.

14. The method of claim 8 wherein step b) further comprises removing alarm information and further comprising:
d) displaying a graphic associated with the second element;
e) obtaining an alarm condition corresponding to the removed alarm information;
f) providing no indication of the alarm in the graphic associated with the upstream element.

15. An system for displaying alarm indications in a system, the system employing hierarchical graphical display elements, the system comprising:
a) a display device operable to display hierarchical graphical display elements;
b) at least one storage device;
c) a processing circuit coupled to the display, the processing circuit operable to
store in the at least one storage device a first set of identifiers associated with a graphic element, the graphic element including one or more child elements, a first child element including a second set of identifiers, the set list of identifiers including identifiers corresponding to at least each of the second set of identifiers,
receive a command changing a status of the first child element, the changing of status changing a number of identifiers included in the second set, and
update the first set of identifiers responsive to the command.

16. The system of claim 15, wherein the processing circuit is further operable to:
cause the display device to display graphical information corresponding to the graphic element;
obtain an alarm associated with a first identifier; and
cause the display device to display a graphical indication of the alarm if the first identifier is associated with the first set of identifiers.

17. The system of claim 16, wherein the processing circuit is further operable to:
cause the display device to display a selectable link graphical element corresponding to each of the one or more child elements.

18. The system of claim 15, wherein the graphic element is a child element of a parent graphic element; and wherein the processing circuit is further operable to update a third set of identifiers responsive to the command, the third set of identifiers associated with the parent graphic element.

19. The system of claim 16, wherein the processing circuit is further operable to cause the display device to display graphical information corresponding to a plurality of graphic elements including the graphical element.
